(19) United States
(12) Patent Application Publication
(10) Pub. No.: US 2009/0104897 A1
(43) Pub. Date: Apr. 23, 2009

(54) SERVICE TRACING CONTROL METHOD, SERVICE TRACING SYSTEM AND RELEVANT TRACING APPARATUS

(76) Inventors: Wenhua Xu, Shenzhen (CN); Yan Li, Shenzhen (CN); Jie Tang, Shenzhen (CN); Xiaomin Shi, Shenzhen (CN)

Correspondence Address: BRINKS HOFER GILSON & LIONE, P.O. BOX 10395, CHICAGO, IL, 60610, US

(21) Appl. No.: 12/342,880

(22) Filed: Dec. 23, 2008

Related U.S. Application Data
(63) Continuation of application No. PCT/CN2007/070341, filed on Jul. 23, 2007.

(30) Foreign Application Priority Data
Jul. 31, 2006 (CN) 200610104038.9

(51) Int. Cl. H04M 3/42; G06F 17/30

(52) U.S. Cl. 455/414.1; 707/3

(57) ABSTRACT

A service tracing control method includes performing conflict detection before sending or executing a tracing control command to a component and handling the components of different tracing status differentially. The present disclosure also provides a service tracing system, a service database, a tracing control server, a tracing agent, and other relevant tracing apparatuses. The present disclosure supports execution of pertinent operations for the components which are in different tracing status, thus overcoming conflict that occurs in the case of activating or deactivating the tracing function of the component.

### CROSS-REFERENCED TO RELATED APPLICATIONS

This application is a continuation of International Application No. PCT/CN2007/070341, filed on Jul. 23, 2007, which claims the priority benefit of China Patent Application No. 200610104038.9, filed with the Chinese Patent Office on Jul. 31, 2006 and entitled “Service Tracing Control Method, Service Tracing System and Relevant Tracing Apparatus”, the contents of which are incorporated herein by reference in their entirety.

### FIELD OF THE DISCLOSURE

The present disclosure relates to the field of communication technologies, and in particular, to a service tracing control method, a service tracing system and a relevant tracing apparatus.

### BACKGROUND

With the development of the communication technology and the increase of service types, the Open Mobile Alliance (OMA) puts forward an OMA Service Provider Environment (OSPE) system for managing and maintaining service lifecycles and tracing services. The OSPE system serves to perform unified management for different services, including deployment, cancellation, tracing, and monitoring of the services. As one of the important functions of an OSPE system, the service tracing function analyzes and locates faults. Currently, the system architecture related to service tracing in an OSPE is shown in FIG. 1 and includes three parts.

An OSPE server is a server that manages service tracing. An OSPE server receives the service tracing control requests from the OSPE requester, including the request of activating service tracing function and the request of deactivating service tracing function, controls a tracing agent to activate and deactivate service tracing function, and receives tracing logs from the tracing agent;

A Service Model And Catalogue (SMAC) is a database that manages and maintains service models and catalog data. A SMAC stores service data, component data, and the dependency between them. An OSPE server may obtain relevant service information from the SMAC through query commands.

A tracing agent is a module deployed on the traced component to handle service tracing. The tracing agent is controlled by an OSPE server and may receive service tracing control commands, including at least a command of activating service tracing and a command of deactivating service tracing.

Based on the foregoing OSPE system architecture, the process of activating the service tracing function is:

The OSPE requester sends a request of activating the service tracing function to the OSPE server. The request carries the requested service and the function control requirement related to the service. For the request of activating the service tracing function, the function control requirement related to the service is “to activate the tracing function”.

2. The OSPE server queries the SMAC about the service dependency, obtains the services related to this service and the components required for the service. Such components are known as related components of the service.

3. The SMAC returns the related component required for tracing the service to the OSPE server.

4. The OSPE server sends a command of activating the service tracing function to the tracing agents of all related components. The command corresponds to the service tracing control request of the OSPE requester and carries the service to be traced and the function control requirements related to the service.

5. The tracing agent of the related component returns a confirmation to the OSPE server.

6. The OSPE server returns a result of activating the function to the OSPE requester.

The process of deactivating the service tracing function is similar. After receiving a request of deactivating the service tracing function, the OSPE server queries and knows the related component of the service and then sends a command of deactivating the service tracing function to the tracing agents of all related component to deactivate the tracing function.

The processes of activating and deactivating the service tracing function mentioned above may result in a component control conflict. For example, as shown in FIG. 2, the tracing of service A requires components 1, 3, and 4. The tracing of service B requires components 2, 3, and 5. After the tracing function request of service A is sent and activated, components 1, 3, and 4 have activated the tracing function. Afterward, if a command is sent to activate the tracing function of service B, components 2, 3, and 5 need to be activated, and component 3 encounters “conflict of activating”. If a command is sent to deactivate the tracing function of service B after the tracing functions of services A and B are activated successfully, this operation is equivalent to deactivating the tracing functions of components 2, 3, and 5, and the tracing of service A is impossible for lack of component 3. In this case, component 3 encounters “conflict of deactivating”.

### SUMMARY

A service tracing control method, a service tracing system, and a relevant tracing apparatus are provided in embodiments of the present disclosure, thus a conflict of activating and deactivating the tracing function of components may be avoided.

A method for controlling service tracing in an embodiment of the present disclosure includes receiving service tracing control requests, querying the dependency of the requested service to obtaining the information of related component of the requested service, performing conflict detection for the related component, and sending a service tracing control command to the related component differentially according to the detection results.

Another method for controlling service tracing in an embodiment of the present disclosure includes receiving service tracing control requests, querying the dependency of the requested service to obtaining the information of related component of the requested service, sending a service tracing control command to the corresponding related component, performing conflict detection for the related component, and executing the service tracing control command for the related component differentially according to the detection results.

A tracing system provided in an embodiment of the present disclosure, includes a tracing control server, a service database, and a Tracing Conflict Management (TCM) module.

The tracing control server is adapted to receive service tracing control requests; send a request of querying dependency of the requested service to the service database and obtain the information of related component of the requested service, send a conflict detection request to the TCM where the conflict detection request carries the information of the related component and the function control requirements in the service tracing control request, and send a service tracing control command to the related component differentially according to the results of conflict detection fed back by the TCM.

The service database provides the tracing control server with information of related component of the service.

The TCM is adapted to detect whether the function control requirement in the service tracing control request conflict with the current tracing status of the related component of the service and feed back the detection results to the tracing control server.

Another tracing system provided in an embodiment of the present disclosure includes a tracing control server, a service database, and a TCM.

The tracing control server is adapted to receive service tracing control requests, send a request of querying dependency of the requested service to the service database, and send a service tracing control command to the related component differentially according to the results of conflict detection fed back by the TCM.

After receiving the query request from the tracing control server, the service database queries the information of related component of the requested service and sends a conflict detection request to the TCM where the conflict detection request carries information of the related component and the function control requirements in the service tracing control request.

The TCM is adapted to detect whether the function control requirement in the service tracing control request conflict with the current tracing status of the related component of the service and feed back the detection results to the tracing control server.

Another tracing system provided in an embodiment of the present disclosure, includes a tracing control server, a service database, and a TCM.

The tracing control server is adapted to receive service tracing control requests, send a request of querying dependency of the requested service to the service database and send a service tracing control command to the related component differentially according to the results of conflict detection fed back by the service database.

After receiving the query request from the tracing control server, the service database queries the information of related component of the requested service, sends a conflict detection request to the TCM where the conflict detection request carries information of the related component and the function control requirements in the service tracing control request, and feeds back the detection results of the TCM to the tracing control server.

The TCM is adapted to detect whether the function control requirement in the service tracing control request conflict with the current tracing status of the related component of the service and feed back the detection results to the service database.

A service database provided in an embodiment of the present disclosure includes a service data management module and a TCM.

The service data management module is adapted to store service data and information of related component, receive a request of querying service dependency where the request carries the requested service and function control requirement related to the service, send the found information of related component and the function control requirements to the TCM, and send detection results of the TCM in response to the query request.

The TCM is adapted to detect whether the function control requirement conflict with the current tracing status of the related component of the service and feed back the detection results to the service data management module.

A tracing control server provided in an embodiment of the present disclosure includes a tracing control module and a TCM.

The tracing control module is adapted to receive service tracing control requests, query to obtain information of related component of the requested service, send the information of related component of the service and the function control requirements in the service tracing control request to the TCM, and send a service tracing control command to the related component differentially according to the results of conflict detection fed back by the TCM.

The TCM is adapted to detect whether the function control requirement in the service tracing control request conflict with the current tracing status of the related component of the service and feed back the detection results to the tracing control module.

A tracing agent set in a component in an embodiment of the present disclosure includes a tracing processing module and a TCM.

The tracing processing module is adapted to receive service tracing control commands, send the function control requirements in the service tracing control command to the TCM, and execute the service tracing control command differentially according to the detection results fed back by the TCM.

The TCM is adapted to detect whether the function control requirement in the service tracing control request conflict with the current tracing status of the components and feed back the detection results to the tracing processing module.

According to the embodiments of the present disclosure, the conflict detection is performed before performing the service tracing control on the components. The components with different tracing status are handled differentially according to the result of the conflict detection, thus the conflict in the case of activating and deactivating the component tracing function is overcome.

### BRIEF DESCRIPTION OF THE DRAWINGS

FIG. 1 shows a schematic structural diagram of an OSPE system in present;

FIG. 2 shows a schematic diagram of a component control conflict according to a tracing method in present;

FIG. 3 shows a schematic flow of a method for activating the service tracing function according to the first embodiment of the present disclosure;

FIG. 4 shows a schematic flowchart of a method for deactivating the service tracing function according to the second embodiment of the present disclosure;

FIG. 5 shows a schematic flowchart of a method for activating the service tracing function according to the third embodiment of the present disclosure;

FIG. 6 shows a schematic flowchart of a method for deactivating the service tracing function according to the fourth embodiment of the present disclosure;

FIG. 7 shows a schematic structural diagram of an OSPE system according to the fifth embodiment of the present disclosure;

FIG. 8 shows a schematic signaling flow in which the OSPE system in the fifth embodiment executes the method in the first embodiment of the present disclosure;

FIG. 9 shows a schematic structural diagram of an OSPE system in the sixth embodiment of the present disclosure;

FIG. 10 shows a schematic signaling flow in which the OSPE system in the sixth embodiment executes the method in the second embodiment of the present disclosure;

FIG. 11 shows a schematic structural diagram of an OSPE system in the seventh embodiment of the present disclosure;

FIG. 12 shows a schematic signaling flow in which the OSPE system in the seventh embodiment executes the method in the first embodiment of the present disclosure;

FIG. 13 shows a schematic structural diagram of an SMAC in the eighth embodiment of the present disclosure;

FIG. 14 shows a schematic structural diagram of an OSPE system that adopts the SMAC in the eighth embodiment of the present disclosure;

FIG. 15 shows a schematic signaling flow in which the OSPE system in FIG. 14 executes the method in the second embodiment of the present disclosure;

FIG. 16 shows a schematic structural diagram of an OSPE server in the ninth embodiment of the present disclosure;

FIG. 17 shows a schematic structural diagram of an OSPE system includes the OSPE server in the ninth embodiment of the present disclosure;

FIG. 18 shows a schematic signaling flow in which the OSPE system in FIG. 17 executes the method in the second embodiment of the present disclosure;

FIG. 19 shows a schematic structural diagram of a tracing agent in the tenth embodiment of the present disclosure;

FIG. 20 shows a schematic structural diagram of an OSPE system includes the tracing agent in the tenth embodiment of the present disclosure; and

FIG. 21 shows a schematic signaling flow in which the OSPE system in FIG. 20 executes the method in the first embodiment of the present disclosure.

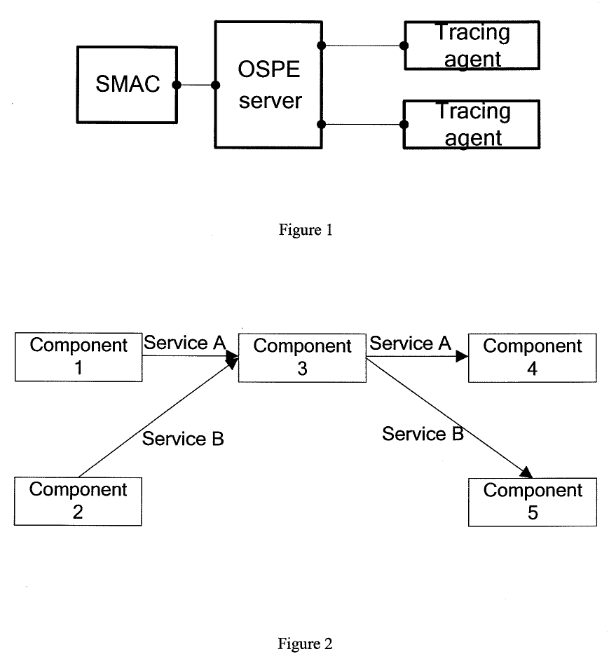

### DETAILED DESCRIPTION

A service tracing control method is provided in an embodiment of the present disclosure, which performs a conflict detection before sending or executing a tracing control command to a component so as to handle the components with different tracing status differentially, thereby avoiding control conflict for the components such as “conflict of activating a service tracing function” and “conflict of deactivating a service tracing function”. The service tracing control method is applicable to the process of activating the service tracing function and the process of deactivating the service tracing function. Conflict detection may be performed in the command generation stage or the command execution stage in the control process. The two processes are almost the same and includes receiving control requests, querying service information, performing conflict detection, and handling the components with different status differentially. The two processes vary in the specific control command and the corresponding control operation as elaborated separately below.

The present disclosure is hereinafter described in detail with reference to embodiments and accompanying drawings.

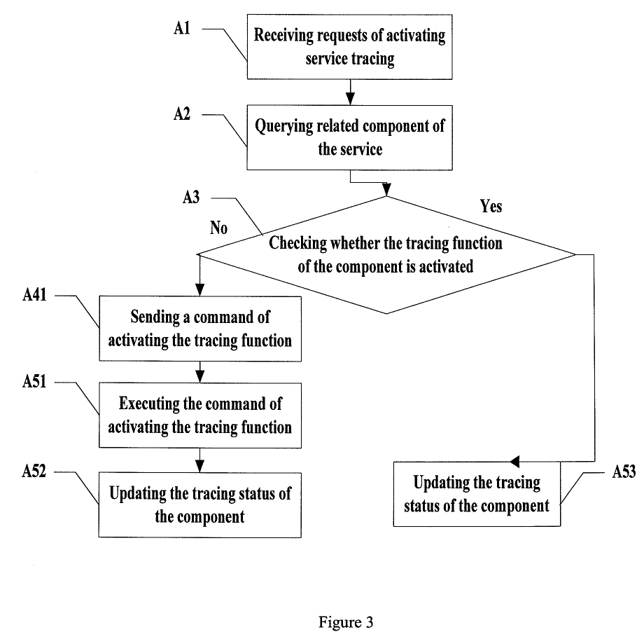

FIG. 3 illustrates a method for activating a service tracing function according to Embodiment 1, which includes:

A1. receiving a request for activating a service tracing function The request is generally sent by an OSPE requester, and the request specifies the service that needs to be traced and the function control requirement related to the service, referred to as “activating the tracing function”;

A2. querying the service dependency according to the service specified in the request, namely, obtaining the information of related component of the service, etc;

A3. performing a conflict detection for the related component according to the information of related component and the function control requirement related to the service and judging whether the function control requirement “activating the tracing function” conflict with the current tracing status of each component, The related component are divided into two parts according to the detection result, namely, conflicting component whose tracing function is activated and non-conflicting component whose tracing function is deactivated;

A4. handling the components differentially according to the conflict detection results, including:

handling the non-conflicting component:

A41. sending a command for activating the tracing function to the components whose tracing function is deactivated;

handling the conflicting component:

not sending a command for activating the tracing function to the components whose tracing function is activated;

A5. performing the subsequent processes for the non-conflicting component and the conflicting component differentially;

for the non-conflicting component:

A51. executing the command of activating the tracing function for the corresponding component to activate the tracing function of the component;

A52. updating the current tracing status of each related component according to the result of executing the command, namely, the executing status of activating the tracing function of the component;

for the conflicting component:

A53. updating the current tracing status of the related component according to the activating tracing function event.

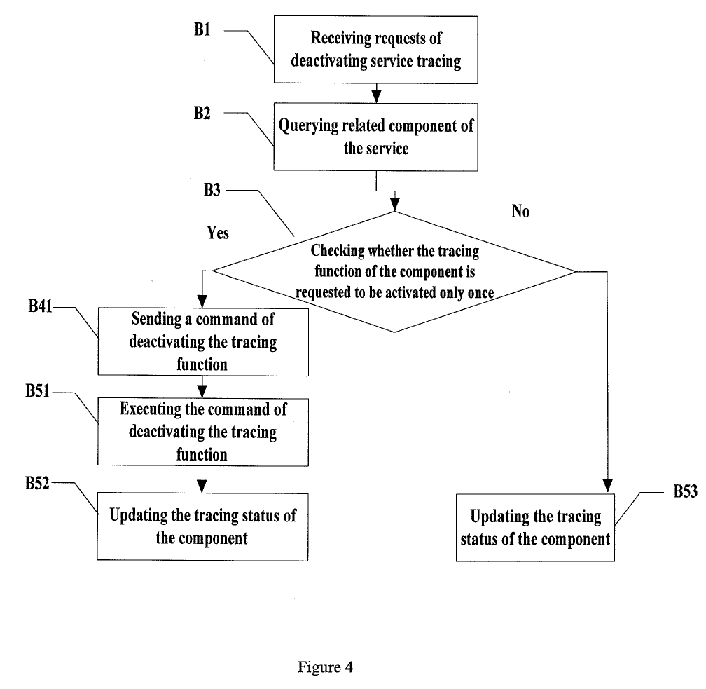

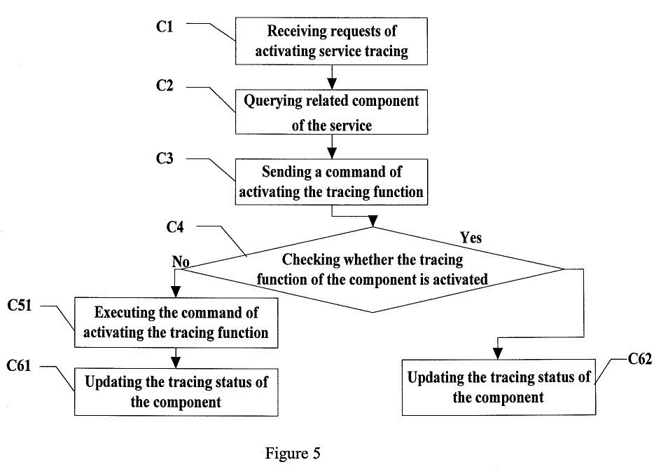

FIG. 4 illustrates a method for deactivating a service tracing function according to Embodiment 2, which includes:

B1. receiving a request for deactivating a service tracing function, in which the request is generally sent by an OSPE requester or automatically generated by an OSPE server or sent by other relevant modules. The request specifies the service that needs to deactivate the tracing and the function control requirement related to the service, referred to as “deactivating the tracing function”;

B2. querying the service dependency according to the service specified in the request, namely, obtaining the information of related component of the service, etc;

B3. performing a conflict detection for the related component according to the information of related component and the function control requirement related to the service and judging whether the function control requirement “deactivating the tracing function” conflict with the current tracing status of each component. The related component are divided into two parts according to the detection result, namely, conflicting component whose tracing function is used by multiple tracing requests and non-conflicting component whose tracing function is used by one tracing request;

B4. handling the components differentially according to the conflict detection result, including:

Handling the non-conflicting component:

B41. sending a command of deactivating the tracing function to the components whose tracing function is used by one tracing request;

handling the conflicting component:

not sending a command for deactivating the tracing function to the components whose tracing function is used by multiple tracing requests;

B5. performing the subsequent processes for the components which are handled differentially after the command of deactivating the tracing function is sent;

for the components to which a command of deactivating the tracing function is sent:

B51. executing the command of deactivating the tracing function for the corresponding component to deactivate the tracing function of the component;

B52. updating the current tracing status of each related component according to the results of executing the command, namely, the status of deactivating the tracing function of the component;

for the components to which command of deactivating the tracing function is not sent:

B53. updating the current tracing status of the related component according to the deactivating tracing function request.

As revealed in the foregoing two embodiments, the conflict detection judges whether the function control operation requested on the component is repetitive or contradictory as against the current tracing status of the component. The criteria of judging come in many types and are herein aggregated in a tracing status table. Conflict detection is performed by querying a tracing status table. After a control command is executed, the tracing status table is updated according to the execution results. The data structure of a tracing status table is exemplified below, but is not limited to the following:

records the number of times of invoking a component whose tracing function is activated, namely, the number of times of requesting to activate the tracing function of the component. The data structure is as follows:

| | |
|---|---|
| Component | Count of invoking |

In the case of querying a tracing status table, during the conflict detection for activating the tracing function, the tracing status table indicates that the tracing function of the component is activated, if a component already exists in the component box. During the conflict detection for deactivating the tracing function, the tracing status table indicates that the tracing function of the component is requested to be activated repeatedly, if the number of times of invoking the component is equal to or greater than two.

In the case of updating a tracing status table, during an update of activating the tracing function, the number of times of invoking the component increases by one, if a component already exists in the component box of the tracing status table. Otherwise, adds the component into the tracing status table and sets the corresponding count of times of invoking the component to “1” (for the component not recorded in the tracing stable table, the count of times of invoking is zero by default). During an update of deactivating the tracing function, the count of times of invoking the component decreases by one, and deletes the entry of the component if the count of times of invoking the component changes to zero.

The conflict detection process of the above two embodiments is performed before the control command is sent so that the necessity of sending the command is identifiable. The conflict detection process may also be performed after the command is sent and before the command is executed. For the same control command, the components in different tracing status may be handled differently.

Embodiment 3 is shown in FIG. 5, a method for activating a service tracing function includes:

C1. receiving a request of activating a service tracing function, the request specifies the service that needs to be traced and the service-related function control requirement “activating the tracing function”;

C2. querying the service dependency according to the service specified in the request, namely, obtaining the information of related component of the service;

C3. sending a command of activating the tracing function to each related component, the command carries the service that needs to be traced and the service-related function control requirement “activating the tracing function”;

C4. performing conflict detection the component according to the command of activating the tracing function and judging whether the control request “activating the tracing function” conflict with the current tracing status of the component. If the tracing function is currently activated for the component, conflict exists. Otherwise, no conflict exists;

C5. handling the components differentially according to the conflict detection results, including:

handling the non-conflicting component:

C51. executing the command of activating the tracing function for the component to activate the tracing function of the component;

handling the conflicting component:

not executing command of activating the tracing function;

C6. performing the subsequent processes for the components which are handled differentially after the command of activating the tracing function is executed;

in the case that the command of activating the tracing function is executed:

C61. updating the current tracing status of the related component according to the results of executing the command of activating the tracing function on the component, namely, the status of activating the tracing function on the component;

in the case that command of activating the tracing function is not executed:

C62. updating the current tracing status of the related component according to the activating tracing function request.

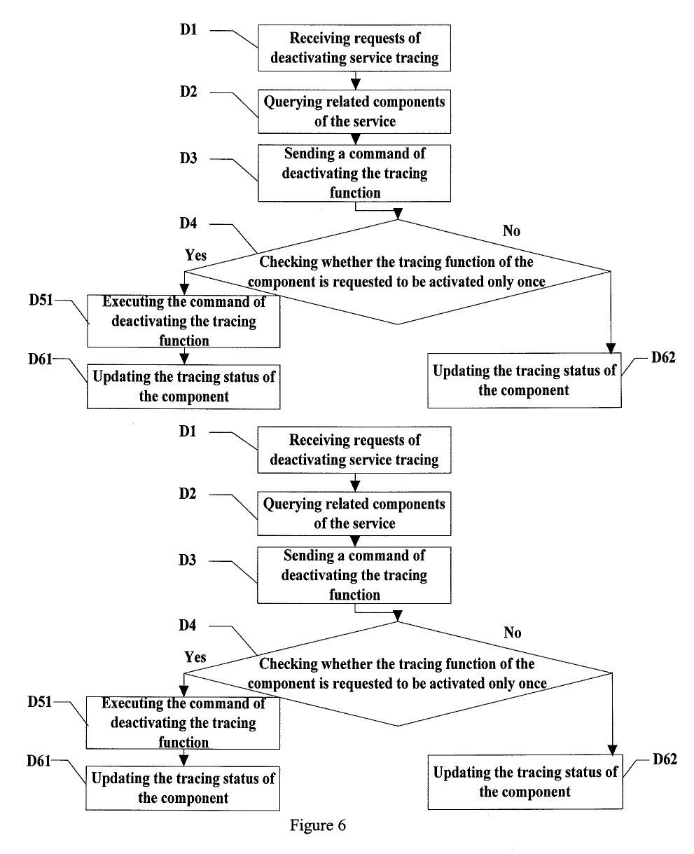

Embodiment 4 is shown in FIG. 6, a method for deactivating a service tracing function includes:

D1. receiving a request of deactivating a service tracing function, the request specifies the service that needs no more tracing and the service-related function control requirement “deactivating the tracing function”;

D2. querying the service dependency according to the service specified in the request, namely, obtaining the information of related component of the service;

D3. sending a command of deactivating the tracing function to each related component, the command carries the service that needs to be traced and the service-related function control requirement;

D4. performing conflict detection the component according to the command of deactivating the tracing function and judging whether the control request “deactivating the tracing function” conflict with the current tracing status of the component. If the tracing function of the component is currently used by multiple tracing requests, conflict exists. If the tracing function of the component is currently used by one tracing request, no conflict exists;

D5. handling the components differentially according to the conflict detection results, including:

handling the non-conflicting component:

D51. executing the command of deactivating the tracing function for the component to deactivate the tracing function of the component;

handling the conflicting component:

not executing command of deactivating the tracing function;

D6. performing the subsequent processes for the components which are handled differentially after the command of deactivating the tracing function is executed;

in the case that the command of deactivating the tracing function is executed:

D61. updating the current tracing status of the related component according to the results of executing the command of deactivating the tracing function on the component, namely, the status of deactivating the tracing function on the component;

in the case that command of deactivating the tracing function is not executed:

D62. updating the current tracing status of the related component according to the activating tracing function request.

The conflict detection operation according to the service tracing control method in an embodiment of the present disclosure may be performed by adding a Tracing Conflict Management (TCM) in an OSPE system. The TCM may be independent of the modules such as OSPE server, SMAC, and tracing agent and exist in the OSPE system independently, or may be added as a sub-module into the foregoing tracing device. Based on the use of the TCM, multiple new devices and system architectures can be obtained, as detailed below.

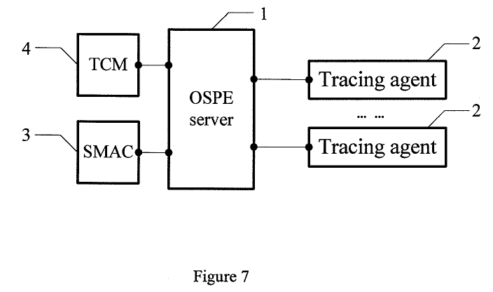

Embodiment 5 is shown in FIG. 7, an OSPE system includes an OSPE server 1, tracing agent 2 (there are more than one tracing agent set in different traced components), an SMAC 3, and a TCM 4.

The OSPE server 1 receives service tracing control requests. The service tracing control requests includes a request of activating the service tracing function or a request of deactivating the service tracing function etc. A service tracing control request carries a requested service and the service-related function control requirement. Moreover, the OSPE server queries the SMAC 3 about the related component of the requested service according to the requested service, sends a conflict detection request to the TCM 4 where the request carries information of related component provided by the SMC 3 and the relevant tracing control request, sends a service tracing control command to the tracing agent 2 of each related component according to the non-conflicting part of the conflict detection results of each component fed back by the TCM 4. The service tracing control commands include the command of activating/deactivating the tracing function of the component and feeds back the results of executing the service tracing control command to the TCM 4.

The SMAC 3 is adapted to store service data, component data, and the dependency relations between them, activate the OSPE server 1 to query the information of related component of the service, and feed back the query results to the OSPE server 1 through a list of related component.

The TCM 4 receives a conflict detection request sent by the OSPE server 1 where the conflict detection request carries information of related component and the function control requirement in the service tracing control request. The TCM 4 judges whether the service-related tracing control request conflict with the current tracing status of each related component and feeds back a result of detecting related component to the OSPE server 1. The result carries the non-conflicting component. The TCM 4 divides the list of related component sent by the OSPE server 1 into two new lists—a list of conflicting component and a list of non-conflicting component after conflict detection. The two lists come in two types. For a tracing control request of the activating type, the two lists refer to a list of components whose tracing function is activated and a list of components whose tracing function is deactivated. For a tracing control request of the deactivating type, the two lists refer to a list of components whose tracing function is used by multiple tracing requests and a list of components whose tracing function is used by one tracing request. The TCM 4 may feed back the detection result which carries the non-conflicting component to the OSPE server 1 through a list. Moreover, the TCM 4 updates the current tracing status of the component. For conflicting component, the TCM 4 performs update according to the function control requirement in the service tracing control request. For non-conflicting component, the TCM 4 updates the current tracing status of the corresponding component according to the result of executing the service tracing control command fed back by the OSPE server 1.

The tracing agent 2 performs service tracing control for the corresponding component according to the service tracing control command sent by the OSPE server 1 and feeds back the result of executing the service tracing control command.

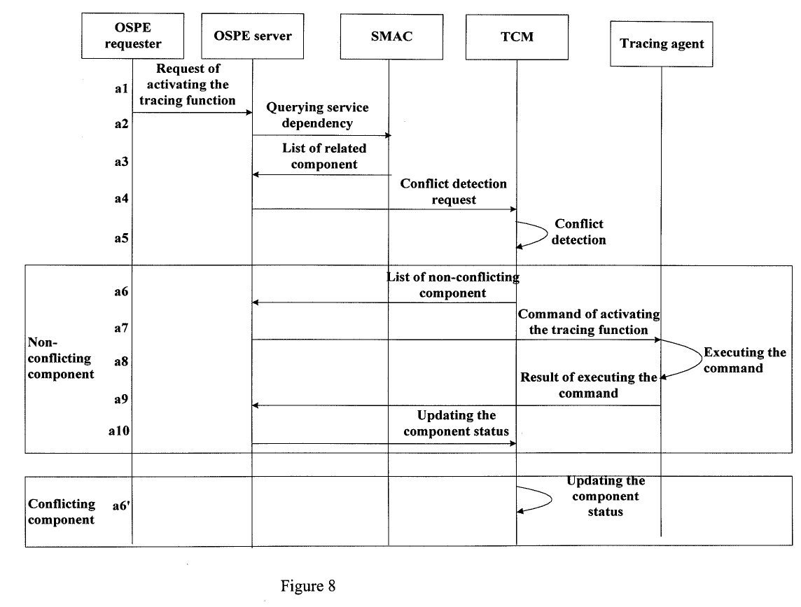

The foregoing OSPE system may save the tracing status table in the TCM 4 by using the service tracing control method provided by the first or second embodiment of the present disclosure. The method for activating the service tracing function in an OSPE system is elaborated below as an example, and the method for deactivating the service tracing function in an OSPE system is similar. As shown in FIG. 8, the signaling flow for activating the service tracing function in an OSPE system includes:

a1. The OSPE server receives a request of activating the service tracing function from an OSPE requester where the request specifies the service that needs to be traced.

a2. The OSPE server queries the SMAC about the service dependency according to the service specified in the request.

a3. According to the specified service, the SMAC queries the service dependency, obtains the services related to tracing of the specified service and the related component required for tracing the service, and returns a list of the components to the OSPE server.

a4. The OSPE server sends a conflict detection request to the TCM where the request carries a list of the components involved in the service tracing request and the relevant control request.

a5. According to the component list and the relevant control request, the TCM queries the tracing status table and divides the components into a list of conflicting component whose tracing function is activated and a list of non-conflicting component whose tracing function is deactivated.

a6′. The TCM updates the status of the components whose tracing function is activated and records the activating service tracing function request.

a6. The TCM returns a conflict detection result to the OSPE server where the result carries a list of non-conflicting component whose tracing function is deactivated.

a7. The OSPE server sends a command of activating the tracing function to the tracing agent of each component in the list of components whose tracing function is deactivated.

a8. The tracing agent executes the tracing command to activate the tracing function of the component.

a9. The tracing agent returns a result of executing the tracing command on the component to the OSPE server.

a10. If the returned result is success of executing the tracing command, the OSPE server feeds back the result to the TCM, and the TCM updates the status of executing the tracing command on the component in the tracing status table.

Step a6′ is a process of executing the command for conflicting component. Steps a6˜a10 refer to a process of executing the command for non-conflicting component. The two processes can be performed concurrently.

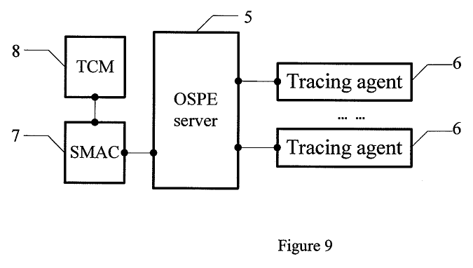

Embodiment 6 is shown in FIG. 9, an OSPE system includes an OSPE server 5, a tracing agent 6, an SMAC 7, and a TCM 8.

The OSPE server 5 receives service tracing control requests. A service tracing control request carries the requested service and the service-related function control requirement. According to the requested service, the OSPE server queries the SMAC 7 about the related component of the requested service. According to the information of non-conflicting related component fed back by the SMAC 7, the OSPE server sends a service tracing control command to the tracing agent 6 of each related component and feeds back the result of executing the service tracing control command to the SMAC 7.

After receiving the query request from the OSPE server 5, the SMAC 7 queries the information of related component and sends a conflict detection request to the TCM 8 where the request carries the information of related component and the function control requirement related to the service. The SMAC 7 feeds back the information of non-conflicting related component returned by the TCM 8 to the OSPE server 5 and forwards the result of executing the service tracing control command returned by the OSPE server 5 to the TCM 8.

The TCM 8 receives the conflict detection request sent by the SMAC 7, judges whether the tracing function control request conflict with the current tracing status of each related component, divides the conflict detection results of the components into conflicting component and non-conflicting component, feeds back the detection results that carry the information of the non-conflicting related component to the SMAC 7, and updates the current tracing status of the components. For conflicting component, the TCM 8 may update the current tracing status according to the function control requirement related to the service directly. For non-conflicting component, the TCM 8 may update the current tracing status of the corresponding component according to the result of executing the service tracing control command fed back by the SMAC 7.

The tracing agent 6 performs service tracing control for the corresponding component according to the service tracing control command sent by the OSPE server 5 and feeds back the result of executing the service tracing control command.

This embodiment and the fifth embodiment adopt an independent TCM, and vary in that in the fifth embodiment, the TCM interacts with the OSPE server only. In this embodiment, the TCM interacts with the SMAC only, receives the list of related component of the SMAC, and generates a conflict detection result and returns it to the SMAC. The feedback from the tracing agent after executing the control command may be transferred to the TCM through the SMAC indirectly.

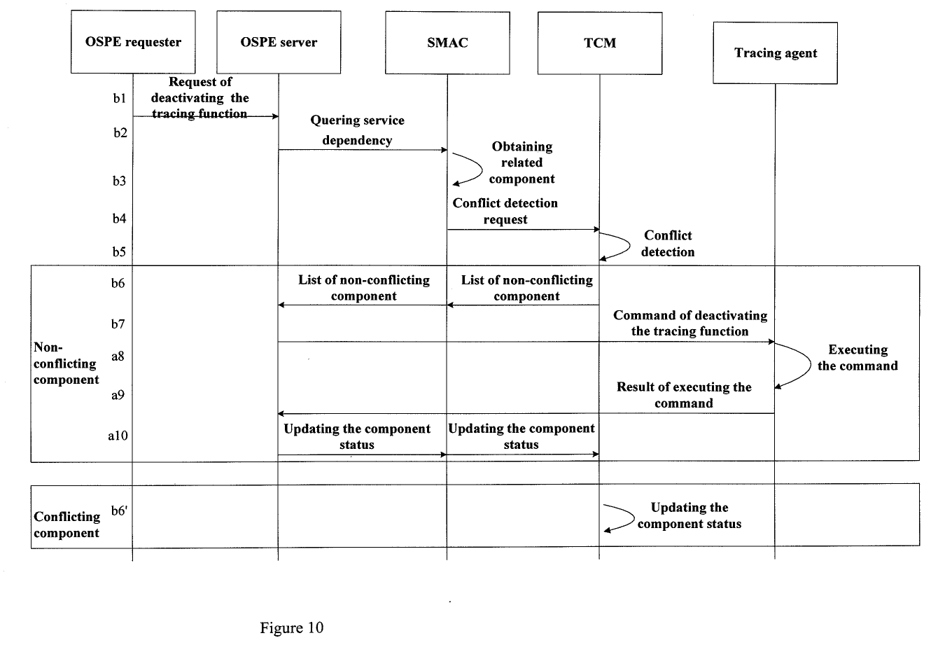

The OSPE system in this embodiment may also adopt the service tracing control method provided by the first or second embodiment of the present disclosure. The method for deactivating the service tracing function in an OSPE system is elaborated below as an example, and the method for activating the service tracing function in an OSPE system is similar. As shown in FIG. 10, the signaling flow for deactivating the service tracing function in an OSPE system includes:

b1. The OSPE server receives a request of deactivating the service tracing function from an OSPE requester where the request specifies the service that needs no more tracing.

b2. The OSPE server queries the SMAC about the service dependency according to the service specified in the request.

b3. According to the specified service, the SMAC queries the service dependency and obtains the services related to tracing of the specified service and the related component required for tracing the service.

b4. The SMAC sends a conflict detection request to the TCM where the request carries a list of the components involved in the service tracing request and the function control requirement related to the service.

b5. According to the component list and the relevant control request, the TCM queries the tracing status table and divides the components into two groups: a list of non-conflicting component whose tracing function is used by one tracing request, and a list of conflicting component whose tracing function is used by multiple tracing requests.

b6′. The TCM updates the status of the components whose tracing function is used by multiple tracing requests and records the deactivating service tracing function request.

b6. The TCM returns a conflict detection result to the SMAC where the result carries a list of non-conflicting component whose tracing function is used by one tracing request. The SMAC transfers the result to the OSPE server.

b7. The OSPE server sends a command of deactivating the tracing function to the tracing agent of each component in the list of components whose tracing function is used by one tracing request.

b8. The tracing agent executes the tracing command to deactivate the tracing function of the component.

b9. The tracing agent returns a result of executing the tracing command on the component to the OSPE server.

b10. If the returned result is success of executing the tracing command, the OSPE server feeds back the result to the TCM, and the TCM updates the status of executing the tracing command on the component in the tracing status table.

Step b6′ is a process of executing the command for conflicting component. Steps b6˜b10 refer to a process of executing the command for non-conflicting component. The two processes may be performed concurrently.

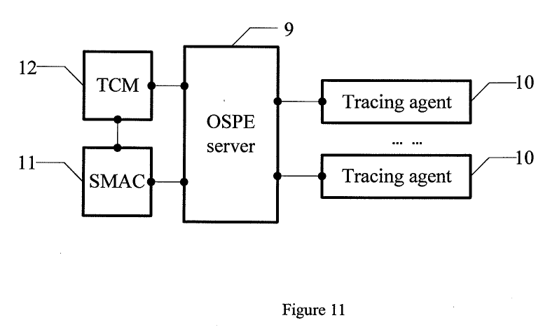

Embodiment 7 is shown in FIG. 11, an OSPE system includes an OSPE server 9, a tracing agent 10, an SMAC 11, and a TCM 12.

The OSPE server 9 receives service tracing control requests and queries the SMAC 11 about the related component of the requested service. According to the conflict detection result of each component fed back by the TCM 12, the OSPE server sends the corresponding service tracing control command to the tracing agent 10 of the related component and feeds back the result of executing the service tracing control command to the TCM 12.

After receiving the query request of the OSPE server 9, the SMAC 11 queries the information of related component and sends a conflict detection request to the TCM 12 where the conflict detection request carries the information of related component and the relevant control request.

The TCM 12 receives the conflict detection request sent by the SMAC 11, judges whether the tracing function control request conflict with the current tracing status of each related component, divides the conflict detection results of the components into conflicting component and non-conflicting component, feeds back the detection results that carry the information of the non-conflicting related component to the OSPE server 9, and updates the current tracing status of the corresponding components according to the results of executing the service tracing control command. Regarding update of the current tracing status of the components, for conflicting component, the TCM 12 may update the current tracing status according to the function control requirement related to the service directly. For non-conflicting component, the TCM 12 may update the current tracing status of the corresponding component according to the result of executing the service tracing control command fed back by the OSPE server 9.

The tracing agent 10 performs service tracing control for the corresponding component according to the service tracing control command sent by the OSPE server 9 and feeds back the result of executing the service tracing control command.

Compared with the preceding two embodiments, this embodiment also adopts an independent TCM, but varies in that:

In this embodiment, the TCM interacts with both OSPE server and SMAC, receives the list of related component of the SMAC, generates a conflict detection result, and returns the detection result carrying the information of non-conflicting related component to the OSPE server directly. The feedback from the tracing agent is returned by the OSPE server to the TCM directly.

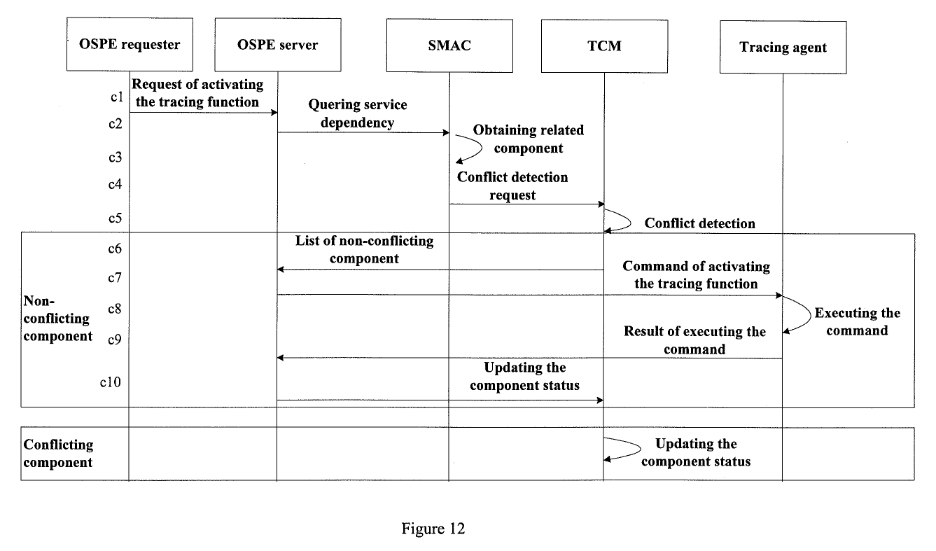

As shown in FIG. 12, a schematic signaling flow for activating the service tracing function in an OSPE system according to this embodiment includes:

c1. The OSPE server receives a request of activating the service tracing function from the OSPE requester.

c2. The OSPE server queries the SMAC about the service dependency according to the service specified in the request.

c3. According to the specified service, the SMAC queries the service dependency, and obtains the services related to tracing of the specified service and the related component required for tracing the service.

c4. The SMAC sends a conflict detection request to the TCM.

c5. According to the component list and the relevant control request, the TCM queries the tracing status table and divides the components into two groups: a list of conflicting component whose tracing function is activated and a list of non-conflicting component whose tracing function is deactivated.

c6′. The TCM updates the status of the components whose tracing function is activated and records the activating service tracing function request.

c6. The TCM returns a conflict detection result to the OSPE server where the conflict detection result carries a list of non-conflicting component whose tracing function is deactivated.

c7. The OSPE server sends a command of activating the tracing function to the tracing agent of each component in the list of components whose tracing function is deactivated.

c8. The tracing agent executes the tracing command to activate the tracing function of the component.

c9. The tracing agent returns a result of executing the tracing command on the component to the OSPE server.

c10. If the returned result is success of executing the tracing command, the OSPE server feeds back the result to the TCM, and the TCM updates the status of executing the tracing command on the component in the tracing status table.

Step c6′ is a process of executing the command for conflicting component. Steps c6˜c10 refer to a process of executing the command for non-conflicting component. The two processes may be performed concurrently.

Embodiments 5˜7 provide schematic structural system solutions for handling the tracing conflict detection independently in a centralized way. In these solutions, the conflict detection function is logically independent of other modules, which is conducive to standardization of the conflict detection function module and unified management of the component status data.

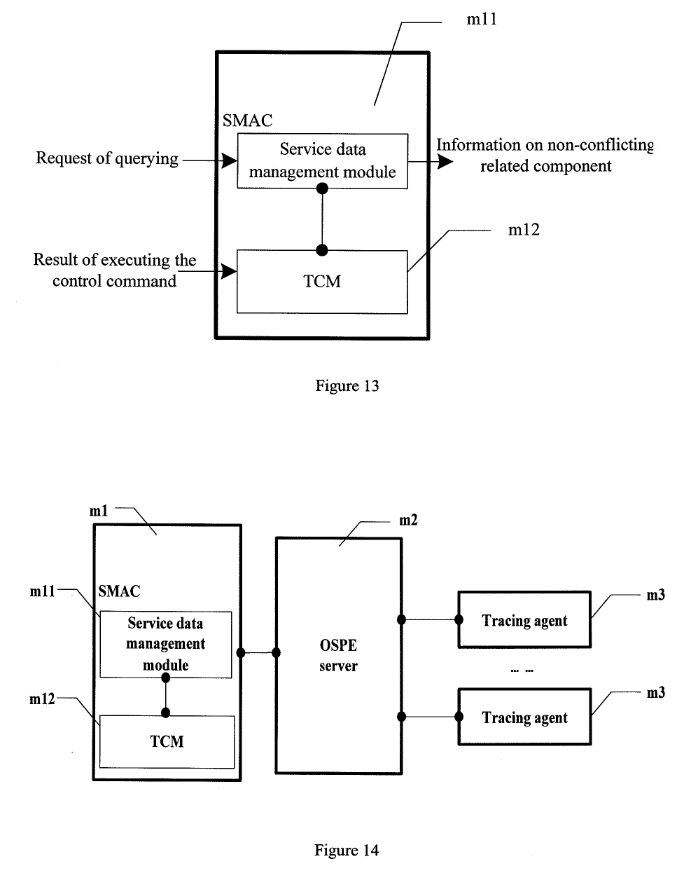

Embodiment 8 is shown in FIG. 13, an SMAC includes a service data management module m11 and a TCM module m12.

The service data management module m11 performs the operations that are generally executed by the SMAC, the operations include:

storing service data and information of related component, receiving a request of querying related component of the service where the query request carries the requested service and the service-related function control requirement; and sending the found information of related component and function control requirement related to the service to the TCM module m12 newly added in the present disclosure, and

sending a conflict detection result carrying information of non-conflicting related component in response to the query request, according to the conflict detection results of the components fed back by the TCM module m12.

The TCM module m12 is responsible for executing the conflict detection operations, including checking whether the tracing function control request conflict with the current tracing status of each related component, feeding back the detection results that carry the information of the non-conflicting related component to the service data management module m11, receiving the results of executing the control command fed back by the component, and updating the current tracing status of the components. For a conflicting component, the TCM may update the current tracing status according to the function control requirement related to the service directly. For a non-conflicting component, the TCM may update the current tracing status of the corresponding component according to the returned result of executing the control command.

FIG. 14 shows a schematic structure of an OSPE system that adopts the foregoing SMAC. The SMAC m1 receives query request sent from the OSPE server m2. The SMAC m1 performs tracing conflict detection internal directly after obtaining the related component of the queried service, returns detection results carrying information of non-conflicting related component to the OSPE server m2. The OSPE server m2 sends the corresponding control command to the tracing agent m3 according to the information of non-conflicting component. The tracing agent executes the command and the execution result may be fed back by the OSPE server m2 to the TCM module m12 in the SMAC m1 through the OSPE server m2 directly.

In this system structure, the conflict detection function is located on the SMAC, and the query function of related component of tracing and the conflict detection function are centralized on the SMAC, thus shortening the handling process.

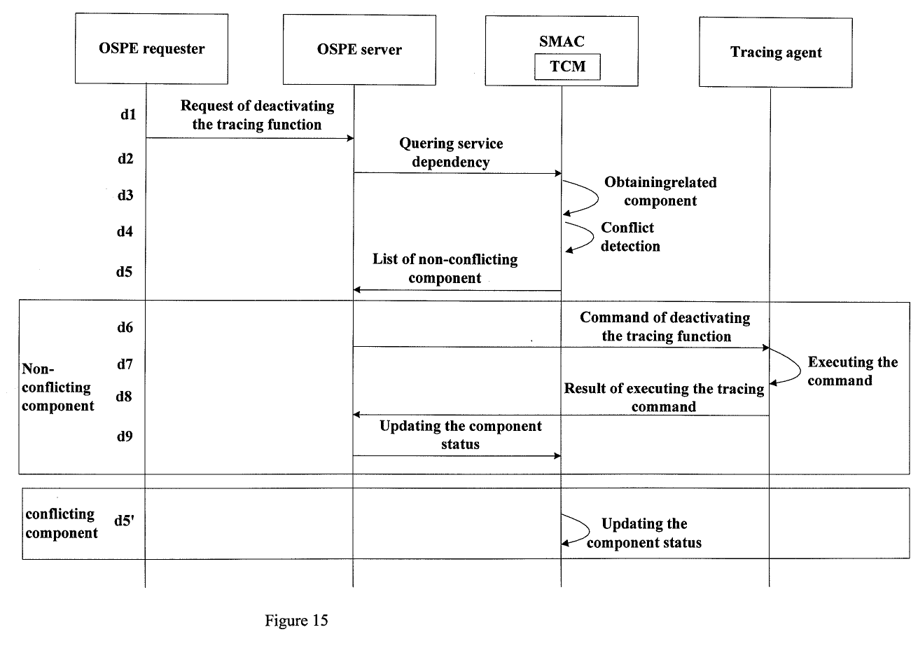

As shown in FIG. 15, the schematic signaling flow for deactivating the service tracing function in an OSPE system according to the second embodiment includes:

d1. The OSPE server receives a request of deactivating the service tracing function from an OSPE requester where the request specifies the service that needs no more tracing.

d2. The OSPE server queries the SMAC about the service dependency according to the service specified in the request.

d3. According to the specified service, the SMAC queries the service dependency and obtains the services related to tracing of the specified service and the related component required for tracing the service.

d4. According to the component list and the relevant control request, the TCM module of the SMAC queries the tracing status table and divides the components into two groups: a list of non-conflicting component whose tracing function is used by one tracing request, and a list of conflicting component whose tracing function is used by multiple tracing requests.

d5′. The TCM module updates the status of the components whose tracing function is used by multiple tracing requests and records the deactivating service tracing function request.

d5. The SMAC returns a conflict detection result to the OSPE server where the conflict detection result carries a list of non-conflicting component whose tracing function is used by one tracing request.

d6. The OSPE server sends a command of deactivating the tracing function to the tracing agent of each component in the list of components whose tracing function is used by one tracing request according to the list of non-conflicting component.

d7. The tracing agent executes the tracing command to deactivate the tracing function of the component.

d8. The tracing agent returns a result of executing the tracing command on the component to the OSPE server.

d9. If the returned result is success of executing the tracing command, the OSPE server feeds back the result to the TCM module of the SMAC, and the TCM module updates the status of executing the tracing command on the component in the tracing status table.

Step d5′ is a process of executing the command for conflicting component. Steps d5˜d9 refer to a process of executing the command for non-conflicting component. The two processes may be performed concurrently.

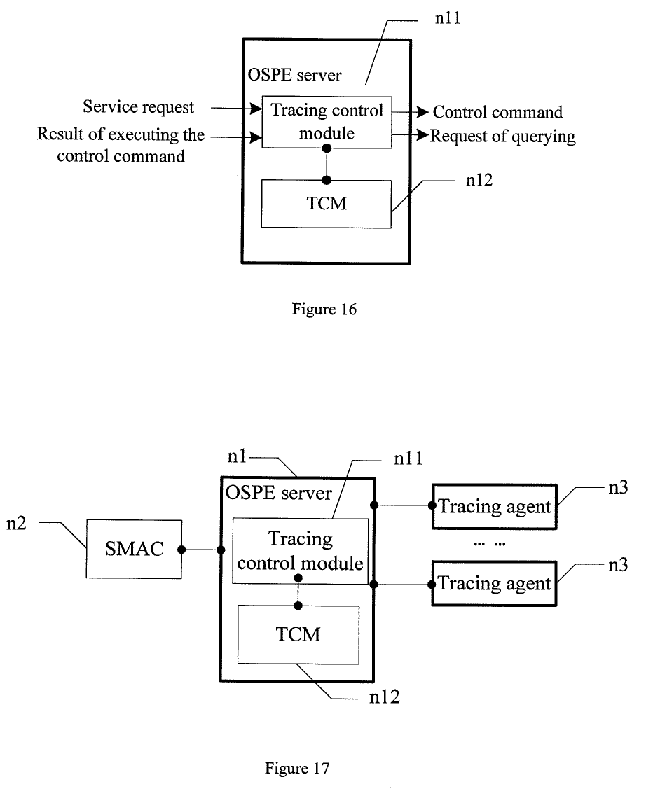

Embodiment 9 is shown in FIG. 16, an OSPE server includes: a tracing control module n11, and a TCM module n12.

The tracing control module n11 performs the operations that are generally executed by the OSPE server, including receiving service tracing control requests, the service tracing control request carrying the requested service and the service-related function control requirements, querying and obtaining information of related component of the specified service, sending the found information of related component and the function control requirement related to the service to a TCM module n12 newly added in the present disclosure; sending a proper service tracing control command according to the result of conflict detection on each component fed back by the TCM module n12, and feeding back the result of executing the service tracing control command to the TCM module n12.

The TCM module n12 is responsible for executing the conflict detection operations, including checking whether the tracing function control request conflict with the current tracing status of each related component, feeding back the detection results that carry the information of non-conflicting related component to the tracing control module n11 and updating the current tracing status of the components. For conflicting component, the TCM may update the current tracing status according to the function control requirement related to the service directly. For non-conflicting component, the TCM may update the current tracing status of the corresponding component according to the returned result of executing the service tracing control command.

FIG. 17 shows an architecture of an OSPE system that adopts an OSPE server. The OSPE server n1 obtains a list of related component of the service by querying the SMAC n2. The TCM module n12 performs tracing conflict detection internally and sends the corresponding control command to the tracing agent n3 according to the detection results. The TCM module n12 of the OSPE server may handle the command execution feedback of the tracing agent n3.

In this system architecture, the conflict detection function is located on the OSPE server and the sending of the tracing command where the conflict detection function and the feedback of the tracing agent are centralized on the OSPE server, thus shortening the handling process.

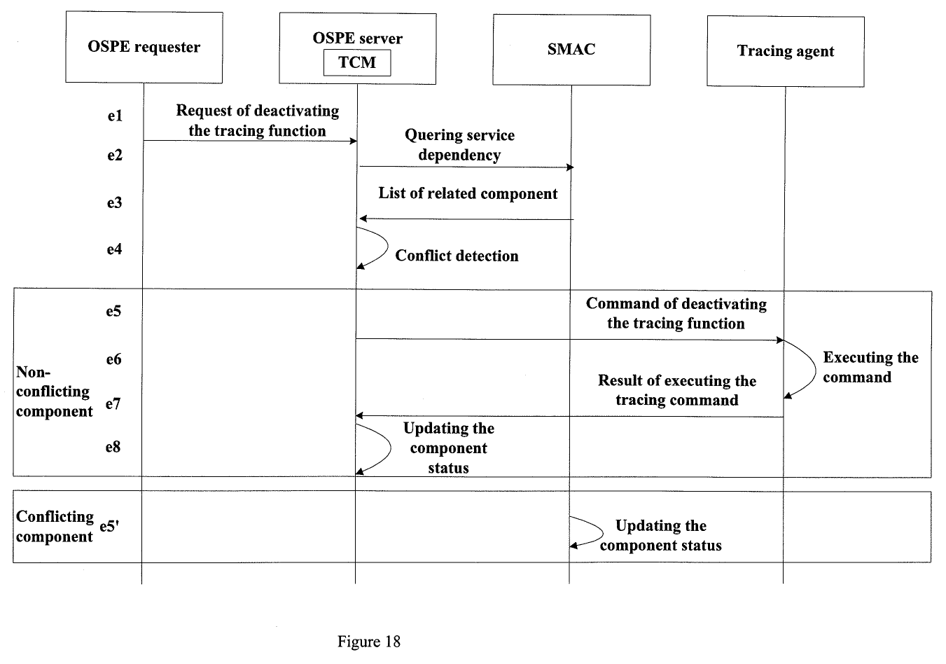

As shown in FIG. 18, a schematic signaling flow for deactivating the service tracing function in an OSPE system according to the second embodiment includes:

e1. The OSPE server receives a request of deactivating the service tracing function of the OSPE requester where the request specifies the service that needs no more tracing and the service-related function control requirement “deactivating the tracing function”.

e2. The OSPE server queries the SMAC about the service dependency according to the service specified in the request.

e3. According to the specified service, the SMAC queries the service dependency, obtains the services related to tracing of the specified service and the related component required for tracing the service, and returns a list of the components to the OSPE server.

e4. According to the component list and the relevant control request, the TCM module of the OSPE server queries the tracing status table and divides the components into two groups: a list of non-conflicting components whose tracing function is used by one tracing request, and a list of conflicting components whose tracing function is used by multiple tracing requests.

e5′. The TCM module updates the status of the components whose tracing function is used by multiple tracing requests and records the deactivating service tracing function request.

e5. The OSPE server sends a command of deactivating the tracing function to the tracing agent of each component in the list of components whose tracing function is used by one tracing request according to the list of non-conflicting component generated by the TCM module.

e6. The tracing agent executes the tracing command to deactivate the tracing function of the component.

e7. The tracing agent returns a result of executing the tracing command on the component to the OSPE server.

e8. If the returned result is success of executing the tracing command, the OSPE server feeds back the result to the TCM module, and the TCM module updates the status of executing the tracing command on the component in the tracing status table.

Step e5′ is a process of executing the command for conflicting component. Steps e5˜e8 refer to a process of executing the command for non-conflicting component. The two processes can be performed concurrently.

In the solutions provided in embodiments 5˜9, the tracing conflict detection module is set at the centralized control side of the OSPE system in a centralized mode. Nevertheless, the tracing conflict detection module may also be located in the tracing agents in a distributed way and perform conflict detection before the tracing agent executes the control command, as exemplified hereinafter.

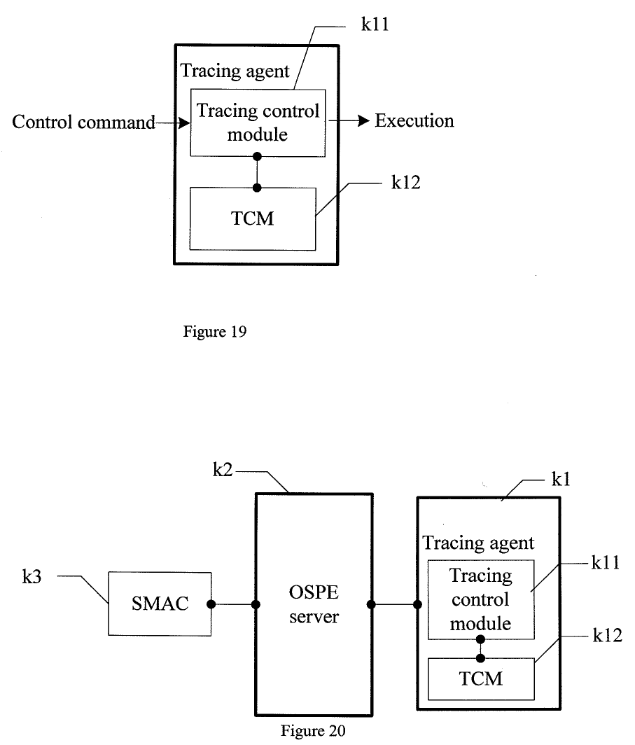

Embodiment 10 is shown in FIG. 19, a tracing agent includes: a tracing processing module k11, and a TCM module k12.

The tracing processing module k11 is responsible for the operations that are generally performed by a tracing agent, including receiving service tracing control commands, sending the tracing function control request to the TCM module k12 newly added in the present disclosure, and handling the tracing commands according to the detection results fed back by the TCM module k12.

The TCM module k12 is responsible for conflict detection, including detecting whether the tracing function control request conflict with the current tracing status of the component, and dividing the detection results into conflicting component and non-conflicting component: for non-conflicting detection results, feeding back the detection results carrying non-conflicting component to the tracing control module k11; for conflicting detection results, updating the tracing status directly.

FIG. 20 shows the architecture of the OSPE system that adopts the foregoing tracing agent (for clearer illustration, one tracing agent is drawn in the figure). The OSPE server k2 obtains a list of related component of the service by querying the SMAC k3, and sends a control command to the tracing agent k1 according to the list of related component. The TCM module k12 of the tracing agent k1 handles the control command differentially after performing conflict detection.

In this system architecture, the conflict detection function is located on the tracing agent, and the component status are stored and processed in a distributed way, thus minimizing the impact on the existing process, shortening the processing flow to the utmost, and improving the processing efficiency. Compared with the centralized mode, the distributed mode requires the system to maintain the tracing status table of the local component.

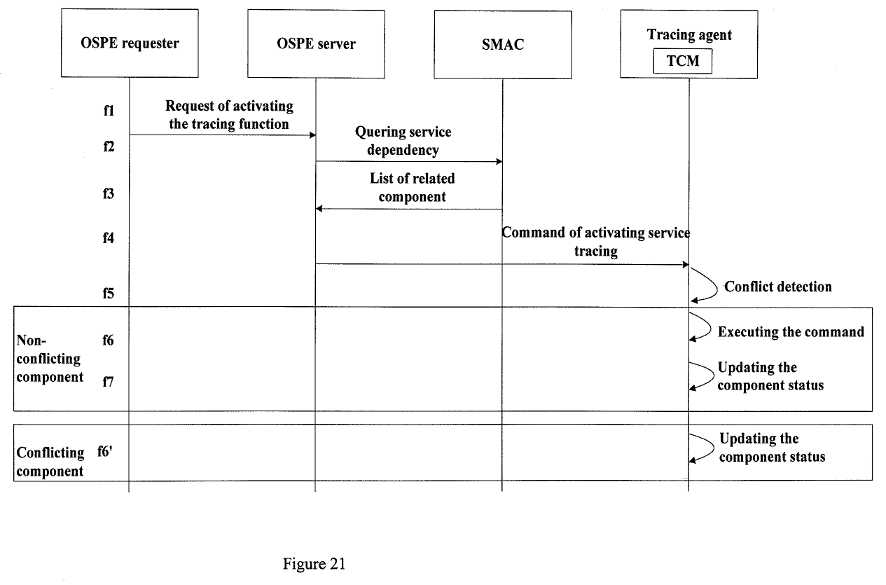

As shown in FIG. 21, the signaling flow for activating the service tracing function in an OSPE system according to the first embodiment includes:

f1. The OSPE server receives a request of activating the service tracing function from the OSPE requester.

f2. The OSPE server queries the SMAC about the service dependency according to the service specified in the request.

f3. According to the specified service, the SMAC queries the service dependency, and obtains the services related to tracing of the specified service and the relevant components required for tracing the service, and returns a list of the components to the OSPE server.

f4. The OSPE server sends a command of activating the service tracing function to tracing agent of each component.

f5. The TCM module of the tracing agent performs conflict detection and queries the tracing status table according to the command of activating the service tracing function. If the tracing function of the component is activated, it indicates that a conflict exists for activating the tracing function. If the tracing function of the component is deactivated, it indicates that no conflict exists for activating the tracing function.

f6′. The TCM module updates the status of the components in the case that the detection result indicates a conflict and records the activating the service tracing function request.

f6. The TCM module executes the command of activating the service tracing function in the case that the detection result indicates no conflict and activates the tracing function of the component.

f7. If the command of activating the service tracing function is executed successfully, the TCM module updates the tracing status table of the corresponding components according to the execution results.

In order to expound the present disclosure clearer, the application of an OSPE system based on the fifth embodiment of the present disclosure is elaborated below, and the application of other solutions may be inferred by analogy.

Dependency relation between a service and components: as shown in FIG. 2, the tracing of service A requires components 1, 3 and 4; the tracing of service B requires components 2, 3 and 5.

The contents about service dependency relations stored in the SMAC may be denoted as follows:

| Service name | Related component |
|---|---|
| Service A | Component 1, component 3, |
| | component 4 |
| Service B | Component 2, component 3, |
| | component 5 |

Suppose that the tracing status table in the TCM is empty initially:

In this application instance, the sequence of the operations is: first tracing service A, then tracing service B, and deactivating tracing of service B. The detailed process is as follows:

I. Activating the Tracing Function of the Components Related to Service A

g1. The OSPE requester requests to activate tracing of service A.

g2. The OSPE server requests the dependency relation of service A from the SMAC.

g3. The SMAC queries the dependency relation of the service according to the service name “service A”, and obtains the component list “component 1, component 3, component 4”. The SMAC returns the component list “component 1, component 3, component 4” to the OSPE server.

g4. The OSPE server requests the TCM to detect conflict. The request carries a list of related component of service A—“component 1, component 3, component 4”, and the function control requirement related to the service “activating the tracing function”.

g5. The TCM queries the tracing status table according to the component list. Because the “component 1, component 3, component 4” list does not exist in the current tracing status table, the component list with deactivated tracing function is “component 1, component 3, component 4”, and the component list with activated tracing function is empty.

g6. The TCM returns the list of components with deactivated tracing function—“component 1, component 3, component 4” to the OSPE server.

g7. The OSPE server sends a command of activating the service tracing function to tracing agents of component 1, component 3 and component 4 respectively.

g8. The tracing agents of component 1, component 3 and component 4 activate the tracing function of component 1, component 3 and component 4 respectively.

g9. The tracing agents of component 1, component 3 and component 4 return the results of executing the tracing command on such components to the OSPE server.

g10. If component 1, component 3 and component 4 return the results of successful execution of the tracing command, the OSPE server feeds back the results to the TCM, and the TCM updates the status of executing the tracing command on the components in the tracing status table. More particularly, the tracing status table is updated in the following way:

The data structure of the tracing status table is composed of “component” and “count of invoking”. In step g10, “component 1”, “component 3”, and “component 4” do not exist in the component box of the tracing status table, so the system adds entries of “component 1”, “component 3”, and “component 4” into the tracing status table. The default count of invoking of such components is zero, and the count of invoking increases by one (namely, is set to “1”). In this case, the contents of the tracing status table include:

| Component | Count of invoking |
|---|---|
| Component 1 | 1 |
| Component 3 | 1 |
| Component 4 | 1 |

II. Activating the Tracing Function of the Components Related to Service B

h1. The OSPE requester requests to activate tracing of service B.

h2. The OSPE server requests the dependency relation of service B from the SMAC.

h3. The SMAC queries the dependency relation of the service according to the service name “service B”, and obtains the component list “component 2, component 3, component 5”. The SMAC returns the component list “component 2, component 3, component 5” to the OSPE server.

h4. The OSPE server requests the TCM to detect conflict. The request carries a list of related component of service B—“component 2, component 3, component 5”, and the function control requirement related to the service “activating the tracing function”.

h5. The TCM queries the tracing status table according to the component list. Because component 3 already exists in the tracing status table, it indicates that the tracing function of component 3 has been activated. Therefore, the component list with the deactivated tracing function is “component 2, component 5”, and the component list with the activated tracing function is “component 3”.

h6. The TCM returns the list of components with deactivated tracing function—“component 2, component 5” to the OSPE server and updates the status table according to the list of components with activated tracing function—“component 3”.

h7. The OSPE server sends a command of activating the tracing function to tracing agents of component 2 and component 5 respectively.

h8. The tracing agents of component 2 and component 5 activate the tracing function of component 2 and component 5 respectively.

h9. The tracing agents of component 2 and component 3 return the results of executing the tracing command on such components to the OSPE server.

h10. If both component 2 and component 3 return a result of successful execution of the tracing command, the OSPE server feeds back the result to the TCM, and the TCM updates the status of executing the tracing command on such components in the tracing status table.

The tracing status table is updated in the following way:

The data structure of the tracing status table is composed of “components” and “count of invoking”. In step h6, component 3 already exists in the component box of the tracing status table, so the count of invoking “component 3” increases by 1, namely, changes to “2”. In step h10, neither component 2 nor component 5 exists in the component box of the tracing status table, the system adds entries of “component 2” and “component 5” in the tracing status table, and the count of invoking both component 2 and component 5 is “1”. In this case, the contents of the tracing status table include:

| Component | Count of invoking |
|---|---|
| Component 1 | 1 |
| Component 2 | 1 |
| Component 3 | 2 |
| Component 4 | 1 |
| Component 5 | 1 |

III. Deactivating the Tracing Function of the Components Related to Service B

i1. The OSPE requester requests to deactivate tracing of service B.

i2. The OSPE server requests the dependency relation of service B from the SMAC.

i3. The SMAC queries the dependency relation of the service according to the service name “service B”, and obtains the component list “component 2, component 3, component 5”. The SMAC returns the component list “component 2, component 3, component 5” to the OSPE server.

i4. The OSPE server requests the TCM to detect conflict; the request carries a list of related component of service B—“component 2, component 3, component 5”, and the function control requirement related to the service “deactivating the tracing function”.

i5. The TCM queries the tracing status table according to the component list. Because the count of invoking component 3 is “2”, conflict of deactivating exists, and component 3 belongs to the list of components whose tracing function is activated by multiple tracing requests. The count of invoking component 2 and component 5 is “1”, no conflict of deactivating exists, and component 2 and component 5 belong to the list of components whose tracing function is activated by one tracing request.

i6. The TCM returns the list of components whose tracing function is used by one tracing request—“component 2, component 5” to the OSPE server and updates the status table according to the list of components whose tracing function is used by multiple tracing requests—“component 3”.

i7. The OSPE server sends a command of deactivating the tracing function to tracing agents of component 2 and component 5 respectively.

i8. The tracing agents of “component 2” and “component 5” deactivate the tracing function of component 2 and component 5.

i9. The tracing agents of component 2 and component 5 return the results of executing the tracing command on such components to the OSPE server.

i10. If both component 2 and component 5 return a result of successful execution of the tracing command, the OSPE server feeds back the result to the TCM, and the TCM updates the status of executing the tracing command on such components in the tracing status table.

The tracing status table is updated in the following way:

The data structure of the tracing status table is composed of “component” and “count of invoking”, and the count of invoking the “component 2, component 3, component 5” involved in tracing of “service B” in the tracing status table decreases by one. Therefore, the count of invoking “component 2” is zero, the count of invoking “component 3” is one, and the count of invoking “component 5” is zero. The system deletes “component 2” and “component 5” from the tracing status table. In this case, the contents of the tracing status table include:

| Component | Count of invoking |
|---|---|
| Component 1 | 1 |
| Component 3 | 1 |
| Component 4 | 1 |

Ordinary technical personnel in this field may understand that all or part of the modules or steps in the preceding embodiments can be completed through a program which instructs related hardware. The program may be stored in a readable storage medium, for example, ROM/RAM, disk and CD in a computer. The programs may be set into different integrated circuit modules, or several modules or steps of the programs may be set into a single integrated circuit module. Therefore, the present disclosure is not limited to any specific combination of hardware and software.

A service tracing control method, a service tracing system, a service database, and tracing apparatuses such as a tracing control server and a tracing agent provided in an embodiment of the present disclosure are elaborated above. Although the disclosure has been described through some exemplary embodiments which help understand the method and essence of the present disclosure, the disclosure is not limited to such embodiments. It is apparent that those skilled in the art can make various modifications and variations to the disclosure without departing from the spirit and scope of the disclosure. The disclosure shall cover such modifications and variations provided that they fall in the scope of protection defined by the following claims or their equivalents.

What is claimed is:

1. A service tracing control method, comprising:
receiving a service tracing control request;
querying a dependency of a requested service to obtain information of related component of the requested service;
performing a conflict detection for the related component; and
sending a service tracing control command to the related component differentially according to a detection result.

2. The service tracing control method according to claim 1, wherein the conflict detection comprises detecting whether the service tracing control request conflict with current tracing status of the related component of the service,
the sending the service tracing control command to the related component differentially according to the detection result comprises:
when a conflict is detected between the service tracing control request and the current tracing status of the related component of the service, not sending the service tracing control command to the related component; or
sending the service tracing control command to the related component when no conflict is detected between the service tracing control request and the current tracing status of the related component of the service.

3. The service tracing control method according to claim 1, wherein the conflict detection comprises detecting whether the service tracing control request conflict with current tracing status of the related component of the service;
the service tracing control request comprises a request of activating the service tracing function, and further comprises:
detecting whether the current tracing function of the related component is activated;
according to the detection result, not sending a command of activating the tracing function to the related component whose tracing function is already activated; and
sending the command of activating the tracing function to the related component whose tracing function is deactivated.

4. The service tracing control method according to claim 1, wherein the conflict detection comprises detecting whether the service tracing control request conflict with current tracing status of the related component of the service;
the service tracing control request comprises a request of deactivating the service tracing function, and further comprises:
detecting a tracing function of the related component is used by one tracing request or multiple tracing requests; and
according to the detection result, not sending a command of deactivating the tracing function to the related component whose tracing function is used by multiple tracing requests; and
sending a command of deactivating the tracing function to the related component whose tracing function is used by one tracing request.

5. A service tracing control method, comprising:
receiving service tracing control requests;
querying dependency of a requested service to obtain information of related component of the requested service;
sending the service tracing control command to the corresponding related component;
performing conflict detection for the related component; and
executing the service tracing control command for the related component differentially according to detection result.

6. The service tracing control method according to claim 5, wherein the executing service tracing control command on the related component differentially according to detection result comprises:
not executing service tracing control command if conflict is detected between the service tracing control request and the current tracing status of the related component of the service; or
executing a service tracing control command if no conflict is detected between the service tracing control request and the current tracing status of the related component of the service.

7. The service tracing control method according to claim 5, further comprising:
detecting whether the service tracing control command conflicts with the current tracing status of the related component of the service;
updating the current tracing status of the related component according to the service tracing request if conflict is detected for an related component; and
updating the current tracing status of the related component according to the results of executing the service tracing control command if no conflict is detected for the related component.

8. The service tracing control method according to claim 5, wherein the service tracing control request comprises a request of deactivating the service tracing function, and further comprises:
detecting the tracing function of the related component is used by one tracing request or multiple tracing requests;
according to the conflict detection result, not executing command of deactivating the tracing function on the related component whose tracing function is used by multiple tracing requests; and executing a command of deactivating the tracing function on the related component whose tracing function is used by one tracing request.

9. A tracing system, comprising a tracing control server, a service database, and a Tracing Conflict Management (TCM), wherein:
the tracing control server is adapted to receive service tracing control request; send a request of querying a dependency of a requested service to the service database, to obtain information of related component of the requested service; send a conflict detection request to the TCM, the conflict detection request carrying the information of the related component and function control requirement related to the service in the service tracing control request; and send a service tracing control command to the related component differentially according to a result of the conflict detection returned by the TCM;
the service database is adapted to provide the tracing control server with the information of related component of the service; and
the TCM is adapted to detect whether the function control requirement related to the service in the service tracing control request conflict with a current tracing status of the related component of the service, and feed back a detection result to the tracing control server.

10. The tracing system according to claim 9, wherein the tracing control server is adapted to send a service tracing control command differentially further comprises:
the tracing control server adapted not to send service tracing control command to the related component detected as colliding and to send a service tracing control command to the related component detected as non-colliding, and to feed back received results of executing the service tracing control command to the TCM; and
the tracing control server further adapted to the return result of executing the service tracing control command to the TCM.

11. The tracing system according to claim 9, wherein:
the TCM is adapted to update the current tracing status of the related component, and update the current tracing status of the related component detected as colliding according to the service tracing request, and update the current tracing status of the related component detected as non-colliding according to a received result of executing the service tracing control command.

12. A tracing system, comprising a tracing control server, a service database, and a Tracing Conflict Management (TCM), wherein:
the tracing control server is adapted to receive service tracing control requests, send a request of querying dependency of a requested service to the service database, and send a service tracing control command to related component differentially according to result of conflict detection;
after receiving the query request from the tracing control server, the service database queries information of related component of the requested service and sends a conflict detection request to the TCM, the conflict detection request carrying information of the related component and function control requirement related to the service in the service tracing control request; and
the TCM is adapted to detect whether the function control requirement in the service tracing control request conflict with the current tracing status of the related component of the service and feed back detection result.

13. The tracing system according to claim 12, wherein the tracing control server is adapted to send a service tracing control command differentially further comprises:
the tracing control server is adapted not to send service tracing control command to the related component detected as colliding, send a service tracing control command to the related component detected as non-colliding, and feed back result of executing the service tracing control command to the TCM.

14. The tracing system according to claim 12, wherein:
the tracing control server is adapted not to send service tracing control command to the related component detected as colliding according to conflict detection result and to send a service tracing control command to the related component detected as non-colliding according to conflict detection result, the tracing control server is further adapted to feed back result of executing the service tracing control command to the TCM via a service database;
the TCM is adapted to update the current tracing status of the related component, and update the current tracing status of the related component detected as colliding by using the activating service tracing request and to update the current tracing status of the related component detected as non-colliding according to received result of executing the service tracing control command.

15. A service database, comprising a service data management module and a Tracing Conflict Management (TCM), wherein:
the service data management module is adapted to store service data and information of related component and receive a request of querying service dependency, the request carrying the requested service and a function control requirement related to the service, send the information of related component and the function control requirement to the TCM module, and send detection result of the TCM in response to the query request; and
the TCM is adapted to detect whether the function control requirement conflict with the current tracing status of the related component of the service and feed back the detection result to the service data management module.

16. A tracing control server, comprising a tracing control module and a Tracing Conflict Management (TCM), wherein:
the tracing control module is adapted to receive a service tracing control request, query to obtain information of related component of the requested service, send the information of related component of the service and a function control requirement related to the service in the service tracing control request to the TCM, and send a service tracing control command to the related component differentially according to a result of a conflict detection fed back by the TCM; and
the TCM is adapted to detect whether the function control requirement in the service tracing control request conflict with the current tracing status of the related component of the service and feed back the result of the conflict detection to the tracing control module.

17. The tracing control server according to claim 16, wherein:
the tracing control module is adapted not to send the service tracing control command to the related component detected as colliding and is adapted to send the service tracing control command to the related component detected as non-colliding, and feed back a result of executing the service tracing control command to the TCM; and
the TCM is adapted to update the current tracing status of the related component detected as colliding by using the an activating service tracing request and update the current tracing status of the related component detected as non-colliding according to the received result of executing the service tracing control command.

18. A tracing agent, comprising a tracing processing module and a Tracing Conflict Management (TCM), wherein:
the tracing processing module is adapted to receive a service tracing control command, send a function control requirement related to the service in the service tracing control command to the TCM, and execute the service tracing control command according to a detection result fed back by the TCM; and
the TCM is adapted to detect whether the function control requirement in the service tracing control request conflict with a current tracing status of the related component and feed back the detection result to the tracing processing module.

19. The tracing agent according to claim 18, wherein the tracing processing module is adapted not to execute the service tracing control command if the detection result indicate a conflict, and is adapted to execute the service tracing control command if the detection result indicate no conflict, the tracing processing module is further adapted to feed back the result of executing the service tracing control command to the TCM.

20. The tracing agent according to claim 18, wherein the TCM is adapted to:
update the current tracing status of the related component and update the current tracing status of the related component detected as colliding by using the function control requirement; and
update the current tracing status of the related component detected as non-colliding according to the result of executing the service tracing control command.
